(19) United States
(12) Patent Application Publication
(10) Pub. No.: US 2026/0257237 A1
(43) Pub. Date: Sep. 3, 2026

(54) Shield Device

(71) Applicant: Richard Orr, Saint Paul, MN (US)

(72) Inventor: Richard Orr, Saint Paul, MN (US)

(21) Appl. No.: 19/067,297

(22) Filed: Feb. 28, 2025

(51) Int. Cl. B05B 12/34; B05B 12/22; B25G 1/04; B25G 3/38

(52) U.S. Cl. CPC B05B 12/34; B05B 12/22; B25G 1/04; B25G 3/38

(57) ABSTRACT

A shield device for shielding an area from being painted includes a panel defining a continuous surface wherein the panel is designed for positioning to cover a covered surface while a substance is applied to an exposed surface. A pair of wings are pivotably coupled to the panel wherein each wing of the pair of wings is pivotable forwardly and backwardly relative to the panel. A handle is coupled to the panel wherein the handle is designed to facilitate positioning the panel to cover the covered surface. The handle includes a grip extending from the panel. A finger is pivotably coupled to the grip wherein the finger is pivotable upwardly and downwardly relative to the grip to adjust an angle between the panel and the handle. An arm is coupled to and extends from the finger.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to covers and more particularly pertains to a new cover for shielding an area from being painted.

### (2) Description of Related Art Including Information Disclosed Under 37 CFR 1.97 and 1.98

The prior art relates to covers. More specifically, the prior art relates to devices for covering, or shielding, certain areas while a surface is being painted. Examples of such devices include painter's tape, which can removably adhere to the surface to shield the area underneath the painter's tape while the surface is painted. Painter's tape is very useful for shielding junctions between surfaces, for example being applied along an edge of a ceiling that intersects with a wall which is being painted. Similarly, painter's tape may be adhered to baseboards to inhibit paint from being applied to the baseboards as a wall is painted. However, painter's tape is time consuming to apply and remove. It is also very thin, further increasing the amount of time and resources needed to cover an area which is larger than the width of the painter's tape. Thus, there is a need in the art for a cover which can be removably positioned over an area to shield that area from paint. Ideally, such a device would be easy to manipulate with a single hand and would be configured to cover corners as well as flat surfaces.

### (h) Brief Summary of the Invention

An embodiment of the disclosure meets the needs presented above by generally comprising a panel defining a continuous surface wherein the panel is designed for positioning to cover a covered surface while a substance is applied to an exposed surface. A pair of wings are pivotably coupled to the panel wherein each wing of the pair of wings is pivotable forwardly and backwardly relative to the panel. A handle is coupled to the panel wherein the handle is designed to facilitate positioning the panel to cover the covered surface. The handle includes a grip extending from the panel. A finger is pivotably coupled to the grip wherein the finger is pivotable upwardly and downwardly relative to the grip to adjust an angle between the panel and the handle. An arm is coupled to and extends from the finger.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a shield device according to an embodiment of the disclosure.

FIG. 2 is a bottom view of an embodiment of the disclosure.

FIG. 3 is a side view of an embodiment of the disclosure.

FIG. 4 is a top view of an embodiment of the disclosure.

FIG. 5 is a detail view of an embodiment of the disclosure.

FIG. 6 is an in-use view of an embodiment of the disclosure.

### (j) DETAILED DESCRIPTION OF THE INVENTION

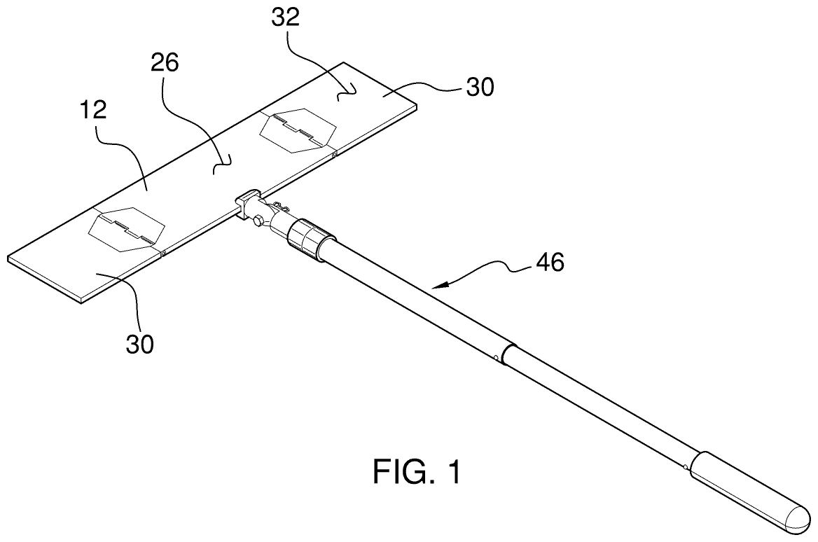

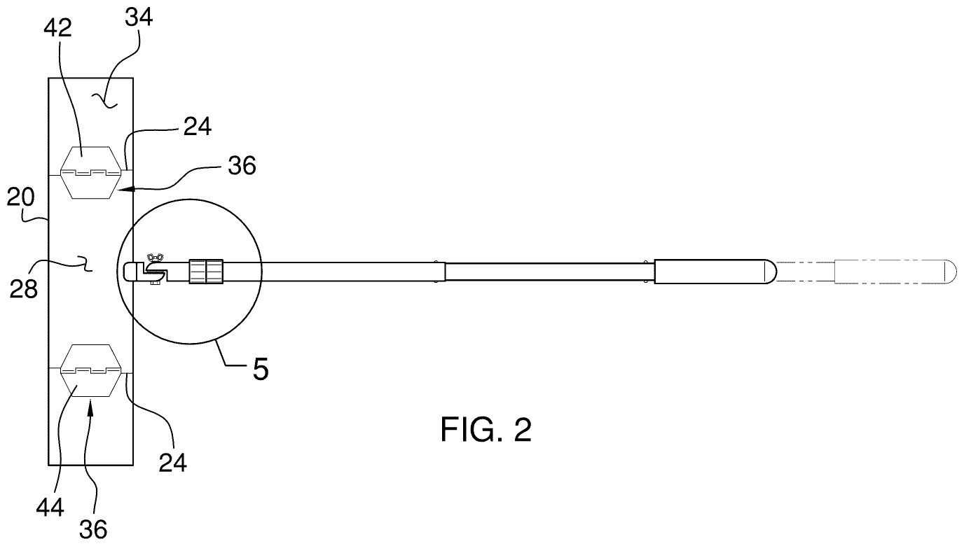

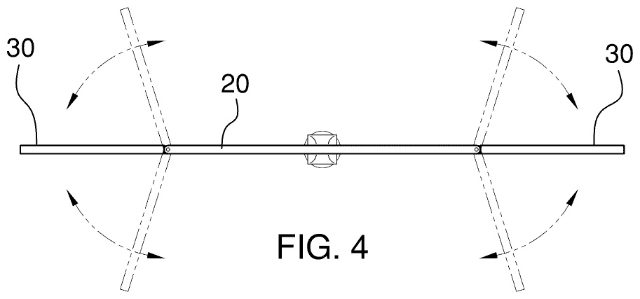

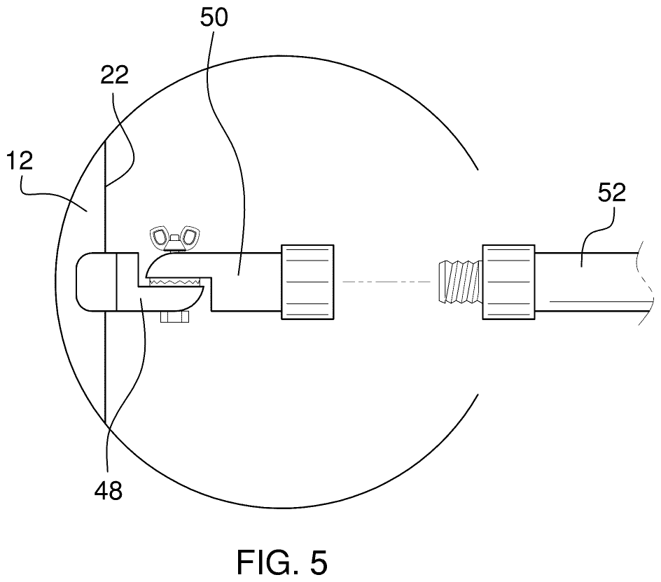

With reference now to the drawings, and in particular to FIGS. 1 through 6 thereof, a new cover embodying the principles and concepts of an embodiment of the disclosure and generally designated by the reference numeral 10 will be described.

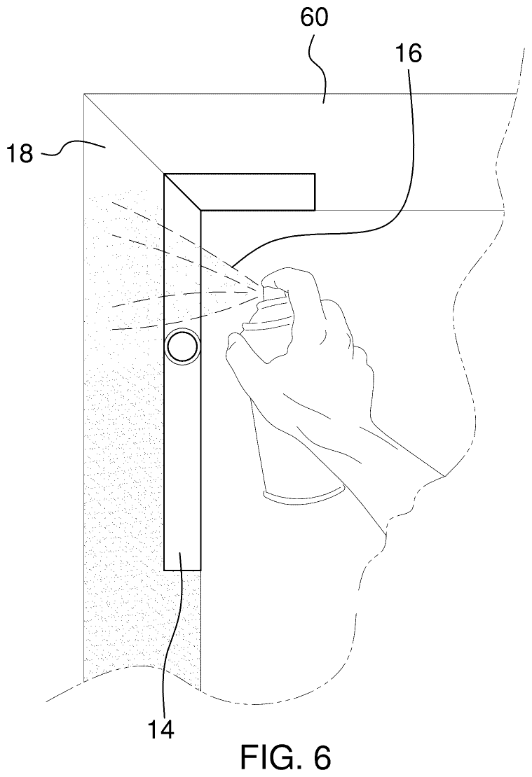

As best illustrated in FIGS. 1 through 6, the shield device 10 generally comprises a panel 12 that defines a continuous surface wherein the panel 12 is configured for positioning to cover a covered surface 14 while a substance 16 is applied to an exposed surface 18. The covered surface 14 is generally an area of a wall, ceiling, or other area that is adjacent to the exposed surface 18. The exposed surface 18 is the portion of that wall, ceiling, or other area to which the user wants to apply the substance 16. The covered surface 14 is the portion of that wall, ceiling, or other area to which the user does not want to apply the substance 16. Therefore, the covered surface 14 is generally the portion of that area which is covered by the panel 12. For example, the user may be painting a portion of a wall that defines the exposed surface 18. The covered surface 14 may be a nearby area of the wall that the user wants to avoid applying the substance 16. As indicated by FIG. 6, the substance 16 may be an aerosolized paint, although other embodiments such as non-aerosolized paint, stains and adhesives are also contemplated.

The panel 12 may have a top edge 20, a bottom edge 22, and a pair of side edges 24 that are coupled to and extend between the top edge 20 and the bottom edge 22. The panel 12 may have a front side 26 which may be planar wherein the front side 26 is configured to be positionable flush against the covered surface 14 when the covered surface 14 is planar. The panel 12 may also have a back side 28 that may be planar wherein the back side 28 is configured to be positionable flush against the covered surface 14 when the covered surface 14 is planar. The pair of side edges 24 may be perpendicular to each of the top edge 20 and the bottom edge 22 wherein the panel 12 is rectangular.

A pair of wings 30 may be pivotably coupled to the panel 12 wherein each wing of the pair of wings 30 is pivotable forwardly and backwardly relative to the panel 12. The pair of wings 30 may be configured for positioning at a junction between the covered surface 14 and an intersecting surface 60 to inhibit the substance 16 from being applied to the covered surface 14 and the intersecting surface 60. For example, the intersecting surface 60 may be another wall. The junction may be a corner between the covered surface 14 and the intersecting surface 60, which may be angled to extend outwardly from the covered surface 14. Each wing of the pair of wings 30 can be pivoted forwardly or backwardly so that a respective wing of the pair of wings 30 can cover the intersecting surface 60 while the panel 12 covers the covered surface 14.

Each wing of the pair of wings 30 is generally positioned to extend from a respective side edge of the pair of side edges 24. For example, each wing of the pair of wings 30 may have a forward face 32, which may be coplanar with the front side 26 of the panel 12 when each wing of the pair of wings 30 is parallel to the panel 12. The forward face 32 may be planar wherein the forward face 32 is configured to be positionable flush against the intersecting surface 60 when the covered surface 14 is planar.

A rearward face 34 may be coplanar with the back side 28 of the panel 12 when each wing of the pair of wings 30 is parallel to the panel 12. The rearward face 34 mat be planar wherein the rearward face 34 is configured to be positionable flush against the intersecting surface 60 when the intersecting surface 60 is planar.

A plurality of couplers 36 may pivotably attach the pair of wings 30 to the panel 12. Each coupler of the plurality of couplers 36 is forwardly and backwardly pivotable wherein the plurality of couplers 36 facilitate each wing of the pair of wings 30 in pivoting forwardly and backwardly relative to the panel 12. For example, each coupler of the plurality of couplers 36 may be a double action hinge.

The plurality of couplers 36 may include a primary member 38 that is positioned to extend between the front side 26 of the panel 12 and the forward face 32 of a first wing of the pair of wings 30. The primary member 38 may be centered between the top edge 20 and the bottom edge 22 of the panel 12. A secondary member 40 may be positioned to extend between the front side 26 of the panel 12 and the forward face 32 of a second wing of the pair of wings 30. The secondary member 40 may be aligned with the primary member 38 on a horizontal axis extending between the pair of side edges 24 of the panel 12.

A tertiary member 42 may be positioned to extend between the back side 28 of the panel 12 and the rearward face 34 of the first wing of the pair of wings 30. The tertiary member 42 may be centered between the top edge 20 and the bottom edge 22 of the panel 12 wherein the tertiary member 42 is aligned with the primary member 38 on a vertical axis extending between the front side 26 and the back side 28 of the panel 12. The vertical axis is perpendicular to the horizontal axis.

A quaternary member 44 may be positioned to extend between the back side 28 of the panel 12 and the rearward face 34 of the second wing of the pair of wings 30. The quaternary member 44 may be aligned with the tertiary member 42 on the horizontal axis extending between the pair of side edges 24 of the panel 12.

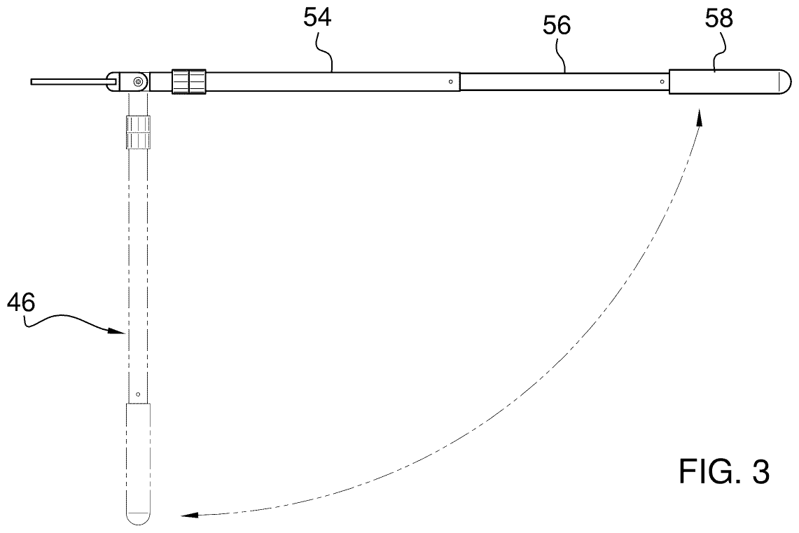

A handle 46 is coupled to the panel 12 wherein the handle 46 is configured to facilitate positioning a selectable one of the front side 26 and the rear side of the panel 12 to cover the covered surface 14. For example, a grip 48 may extend from the bottom edge 22 of the panel 12. The grip 48 may be centered between the pair of side edges 24. A finger 50 may be pivotably coupled to the grip 48 wherein the finger 50 is pivotable upwardly and downwardly relative to the grip 48 to adjust an angle between the panel 12 and the handle 46. By pivoting the finger 50 relative to the grip 48, the handle 46 can be moved upwardly and downwardly relative to the panel 12, as shown in FIG. 3. The finger 50 is distally positioned on the grip 48 relative to the panel 12.

An arm 52 is coupled to and extends from the finger 50. The arm 52 may be elongated wherein the arm 52 is configured to facilitate a user in holding the handle 46 to position the selectable one of the front side 26 and the rear side of the panel 12 to cover the covered surface 14. The arm 52 may include a first rod 54. The first rod 54 may be removably couplable to the finger 50 wherein the first rod 54 facilitates removal of the arm 52 from the finger 50 to facilitate storage of the handle 46. For example, the first rod 54 may be threadably couplable to the finger 50. A second rod 56 may be nested within the first rod 54 wherein the second rod 56 is extendable and retractable relative to the first rod 54 to adjust a length of the arm 52. A third rod 58 may be coupled to the second rod 56 wherein the third rod 58 is distally positioned on the second rod 56 relative to the first rod 54. The third rod 58 may have a diameter exceeding a diameter of the second rod 56 wherein the third rod 58 is positionable to abut the first rod 54 when the second rod 56 is fully retracted into the first rod 54.

In use, the panel 12 can be positioned against the covered surface 14 before the substance 16 is applied to the exposed surface 18. The panel 12 will cover the covered surface 14, preventing the substance 16 from being applied to the covered surface 14. When the covered surface 14 includes a corner, as shown in FIG. 6, one or more wing of the pair of wings 30 can be pivoted relative to the panel 12. The handle 46 facilitates positioning of the panel 12 against the covered surface 14. Because the second rod 56 is extendable and retractable relative to the first rod 54 of the arm 52, the length of the handle 46 is adjustable. The arm 52 can also be removed from the panel 12 by decoupling the arm 52 from the finger 50 of the handle 46. Additionally, because the finger 50 is pivotably coupled to the grip 48, the angle of the arm 52 of the handle 46 relative to the panel 12 is adjustable.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A painting accessory device comprising:
a panel defining a continuous surface wherein the panel is configured for being positioned to cover a covered surface while a substance is applied to an exposed surface;
a pair of wings being pivotably coupled to the panel wherein each wing of the pair of wings is pivotable forwardly and backwardly relative to the panel; and
a handle being coupled to the panel wherein the handle is configured to facilitate positioning the panel to cover the covered surface, the handle including:
a grip extending from the panel;
a finger being pivotably coupled to the grip wherein the finger is pivotable upwardly and downwardly relative to the grip to adjust an angle between the panel and the handle; and
an arm being coupled to and extending from the finger.

2. The painting accessory device of claim 1, the panel further comprising a top edge, a bottom edge, and a pair of side edges being coupled to and extending between the top edge and the bottom edge.

3. The painting accessory device of claim 2, wherein the pair of side edges being perpendicular to each of the top edge and the bottom edge wherein the panel is rectangular.

4. The painting accessory device of claim 2, wherein each wing of the pair of wings is positioned to extend from a respective side edge of the pair of side edges of the panel.

5. The painting accessory device of claim 1, the panel further comprising a front side being planar wherein the front side is configured to be positionable flush against the covered surface when the covered surface is planar.

6. The painting accessory device of claim 5, each wing of the pair of wings further comprising a forward face being coplanar with the front side of the panel when each wing of the pair of wings is parallel to the panel.

7. The painting accessory device of claim 6, wherein the forward face is planar wherein the forward face is configured to be positionable flush against the covered surface when the covered surface is planar.

8. The painting accessory device of claim 5, the panel further comprising a back side being planar wherein the back side is configured to be positionable flush against the covered surface when the covered surface is planar.

9. The painting accessory device of claim 8, each wing of the pair of wings further comprising a rearward face being coplanar with the back side of the panel when each wing of the pair of wings is parallel to the panel.

10. The painting accessory device of claim 9, wherein the rearward face is planar wherein the rearward face is configured to be positionable flush against the covered surface when the covered surface is planar.

11. The painting accessory device of claim 1, wherein the pair of wings are configured for positioning at a junction between the covered surface and an intersecting surface to inhibit the substance from being applied to the covered surface and the intersecting surface.

12. The painting accessory device of claim 1, the arm of the handle further comprising:
a first member being coupled to the finger; and
a second member being nested within the first member wherein the second member is extendable and retractable relative to the first member to adjust a length of the arm.

13. The painting accessory device of claim 12, wherein the first member of the arm is threadably couplable to the finger wherein the first member facilitates removal of the arm from the finger to facilitate storage of the handle.

14. The painting accessory device of claim 13, the arm of the handle further comprising a third member being coupled to the second member wherein the third member is distally positioned on the second member relative to the first member, the third member having a diameter exceeding a diameter of the second member wherein the third member is positionable to abut the first member when the second member is fully retracted into the first member.

15. The painting accessory device of claim 1, further comprising a plurality of couplers pivotably attaching the pair of wings to the panel, each coupler of the plurality of couplers being forwardly and backwardly pivotable wherein the plurality of couplers facilitate each wing of the pair of wings in pivoting forwardly and backwardly relative to the panel.

16. A painting accessory device comprising:
a panel defining a continuous surface wherein the panel is configured for being positioned to cover a covered surface while a substance is applied to a exposed surface, the panel having a top edge, a bottom edge, and a pair of side edges being coupled to and extending between the top edge and the bottom edge, the panel having a front side being planar wherein the front side is configured to be positionable flush against the covered surface when the covered surface is planar, the panel having a back side being planar wherein the back side is configured to be positionable flush against the covered surface when the covered surface is planar, the pair of side edges being perpendicular to each of the top edge and the bottom edge wherein the panel is rectangular;
a pair of wings being pivotably coupled to the panel wherein each wing of the pair of wings is pivotable forwardly and backwardly relative to the panel wherein the pair of wings are configured for positioning at a junction between the covered surface and an intersecting surface to inhibit the substance from being applied to the covered surface and the intersecting surface, each wing of the pair of wings being positioned to extend from a respective side edge of the pair of side edges, each wing of the pair of wings including:
a forward face being coplanar with the front side of the panel when each wing of the pair of wings is parallel to the panel, the forward face being planar wherein the forward face is configured to be positionable flush against the intersecting surface when the intersecting surface is planar; and
a rearward face being coplanar with the back side of the panel when each wing of the pair of wings is parallel to the panel, the rearward face being planar wherein the rearward face is configured to be positionable flush against the intersecting surface when the intersecting surface is planar;
a plurality of couplers pivotably attaching the pair of wings to the panel, each coupler of the plurality of couplers being forwardly and backwardly pivotable wherein the plurality of couplers facilitate each wing of the pair of wings in pivoting forwardly and backwardly relative to the panel, each coupler of the plurality of couplers being a double action hinge, the plurality of couplers including:
a primary member being positioned to extend between the front side of the panel and the forward face of a first wing of the pair of wings, the primary member being centered between the top edge and the bottom edge of the panel;
a secondary member being positioned to extend between the front side of the panel and the forward face of a second wing of the pair of wings, the secondary member being aligned with the primary member on a horizontal axis extending between the pair of side edges of the panel;
a tertiary member being positioned to extend between the back side of the panel and the rearward face of the first wing of the pair of wings, the tertiary member being centered between the top edge and the bottom edge of the panel wherein the tertiary member is aligned with the primary member on a vertical axis extending between the front side and the back side of the panel, the vertical axis being perpendicular to the horizontal axis; and
a quaternary member being positioned to extend between the back side of the panel and the rearward face of the second wing of the pair of wings, the quaternary member being aligned with the tertiary member on the horizontal axis extending between the pair of side edges of the panel;
a handle being coupled to the panel wherein the handle is configured to facilitate positioning a selectable one of the front side and the rear side of the panel to cover the covered surface, the handle including:
a grip extending from the bottom edge of the panel, the grip being centered between the pair of side edges;
a finger being pivotably coupled to the grip wherein the finger is pivotable upwardly and downwardly relative to the grip to adjust an angle between the panel and the handle, the finger being distally positioned on the grip relative to the panel; and
an arm being coupled to and extending from the finger, the arm being elongated wherein the arm is configured to facilitate a user in holding the handle to position the selectable one of the front side and the rear side of the panel to cover the covered surface, the arm including:
a first member being removably couplable to the finger wherein the first member facilitates removal of the arm from the finger to facilitate storage of the handle, the first member being threadably couplable to the finger;
a second member being nested within the first member wherein the second member is extendable and retractable relative to the first member to adjust a length of the arm; and
a third member being coupled to the second member wherein the third member is distally positioned on the second member relative to the first member, the third member having a diameter exceeding a diameter of the second member wherein the third member is positionable to abut the first member when the second member is fully retracted into the first member.
